(19) United States
(12) Patent Application Publication
(10) Pub. No.: US 2007/0206981 A1
(43) Pub. Date: Sep. 6, 2007

(54) Fusing apparatus including a sheet centering stripper assembly

(75) Inventors: Mark S. Amico, Pittsford, NY (US); Martin F. Zess, Churchville, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/365,345

(22) Filed: Mar. 1, 2006

(51) Int. Cl. G03G 15/20

(52) U.S. Cl. 399/323

(57) ABSTRACT

A sheet centering stripping assembly is provided for stripping a fused sheet exiting a fusing nip having a still malleable toner image thereon. The sheet centering stripping assembly includes (a) a first air knife device for directing a first flat stream of pressurized air at a first force to contact a first side of the fused sheet exiting the fusing nip; and (b) a second air knife device for directing a second flat stream of pressurized ionized air at a second force to contact a second and opposite side of the fused sheet exiting the fusing nip, thereby equalizing air flow above and below the fused sheet to prevent smudging of the malleable toner image and minimize curling of such fused sheet.

The present disclosure relates to an electrostatographic reproducing machine and, more particularly, to such a machine including a fusing apparatus having a sheet centering stripper assembly.

One type of electrostatographic reproducing machine is a xerographic copier or printer. In a typical xerographic copier or printer, a photoreceptor surface, for example that of a drum, is generally arranged to move in an endless path through the various processing stations of the xerographic process. As in most xerographic machines, a light image of an original document is projected or scanned onto a uniformly charged surface of a photoreceptor to form an electrostatic latent image thereon. Thereafter, the latent image is developed with an oppositely charged powdered developing material called toner to form a toner image corresponding to the latent image on the photoreceptor surface. When the photoreceptor surface is reusable, the toner image is then electrostatically transferred to a recording medium, such as paper, and the surface of the photoreceptor is cleaned and prepared to be used once again for the reproduction of a copy of an original. The paper with the powdered toner thereon in imagewise configuration is separated from the photoreceptor and moved through a fuser apparatus to permanently fix or fuse the toner image to the paper.

One approach to fixing, or “fusing,” the toner image is applying heat and pressure by passing the copy sheet carrying the unfused toner image between a pair of opposed roller members of a fusing apparatus, at least one of the rollers is heated. During this procedure, the temperature of the toner material is elevated to a temperature at which the toner material coalesces and becomes tacky. This heating causes the toner to flow to some extent into the fibers or pores of the sheet. Thereafter, as the toner material cools, solidification of the toner material causes the toner material to become bonded to the sheet.

After the fusing step, the sheet carrying the fused image is stripped from the fusing member and then fed to a subsequent processing station, such as an inverter, collator, stapler, or booklet maker. Sheets or media exiting the fuser or fusing station usually are charged with static electricity, and in addition the just fused images contain toner that is still in a malleable condition.

Despite these conditions, prior art stripper finger assemblies typically involve solid rigid fingers that either slide away from the fuser surface or include expensive articulating assemblies for attempting to achieve similar results.

Examples of fusing apparatus including such prior art stripper finger assemblies are disclosed in the following references. U.S. Pat. No. 6,293,545 issued Sep. 25, 2001 and entitled “Stripper blade assembly” discloses a stripper blade assembly for an ink jet offset printer that has a thin blade fixedly mounted on a top surface of a blade holder. The blade holder includes at a trailing edge flexible eyelet portions that extend downwards to snap over protuberances on mechanical connectors overmolded onto a rotatable shaft in order to secure the blade holder to the shaft. The thin blade engages the surface of an offset drum of the ink jet offset printer along the width of the drum at an appropriate point in the print process to strip the leading edge of a print medium from the offset drum surface, minimizing damage to the offset drum surface and to the printed image on the print medium while also minimizing the risk of a jam.

U.S. Pat. No. 4,929,983 issued May 29, 1990 and entitled “Stripper mechanism” discloses a stripper for separating a printed substrate from a fuser member in an electrostatographic printing machine that has a substantially flat, thin, resiliently flexible finger-like member having a raised dimple-like bump adjacent one end of the finger-like member for contacting the printed substrate when stripped from the fuser member, the finger-like member being coated on both sides with a smooth low surface energy film.

U.S. Pat. No. 4,806,985 issued Feb. 21, 1989 and entitled “Stripper fingers” discloses a sheet stripping device for electrostatographic systems that includes a frame, a member having movable surface for conveying a receiving sheet, and a sheet stripping element for separating the receiving sheet from the movable surface, the sheet stripping element including a stripping element having a leading edge adapted to contact the movable surface and strip the sheet from the movable surface, the leading edge coated with a material including an electrically conductive material comprising a film forming polymer and an electrically conductive additive. The leading edge may include a thermally resistant polymer of cross-linked siloxane-silica hybrid material, a polyimide or a poly(amide-imide). The sheet stripping means may be prepared by coating the leading edges of preformed stripping elements.

U.S. Pat. No. 4,527,509 issued Jul. 9, 1985 and entitled “Dielectric film processor” discloses a processor that is designed to develop imaged film in sheet or roll form, using a leaderless system employing edge guiding of the film. In this design the exposed film is transported in such a manner that no physical contact is made with the image area by any part of the processor until the image has been fused onto the film. The toned and fused image is permanent and smudge proof. The processor, as it is designed, has the capability of using different toners, adjusting film speed to meet toning and fusing requirements, changing fusing temperature depending on the toner at a given film speed, and adjusting the action of the air knife to improve its capability of the toned image prior to fusing. The processor is compact and lightweight, and the design gives due consideration to the health and safety of the operator. An important feature is the toner tray, which has multiple inlets for toner with a central discharge to protect the film that is being processed from scratching.

A conventional form of air sheet stripping assist system has already been introduced in the Xerox corporation iGEN3 and the DocuFamily of products image producing machines (iGEN3 and the Docu are trademarks of Xerox corporation). This conventional air stripping system includes several strategically placed air nozzles that have small individual holes or orifices for producing jets of pressurized air to assist the sheet or media in stripping off the roll/belt. Air knifes that incorporate individual holes to strip media off a roll/belt have been found to cause and show image defects in the locations where the individual air jets initially hit or contact the roll/belt. This is due to minute time differences in releasing the media between locations directly in line with the air holes and locations away or adjacent the hole, that is, locations where no direct air jet is present. This minute difference in time typically manifests itself as a gloss defect.

In accordance to the present disclosure, there is provided a sheet centering stripping assembly for stripping a fused sheet exiting a fusing nip having a still malleable toner image thereon. The sheet centering stripping assembly includes (a) a first air knife device for directing a first flat stream of pressurized air at a first force and a first pressure, the first flat stream of pressurized air adapted to contact a first side of the fused sheet exiting the fusing nip; and (b) a second air knife device for directing a second flat stream of pressurized air at a second force and a second pressure, the second flat stream of pressurized air adapted to contact a second and opposite side of the fused sheet exiting the fusing nip. The pressure balance between the first flat stream and second flat stream acts to prevent smudging of the malleable toner image, and to minimize curling of such fused sheet.

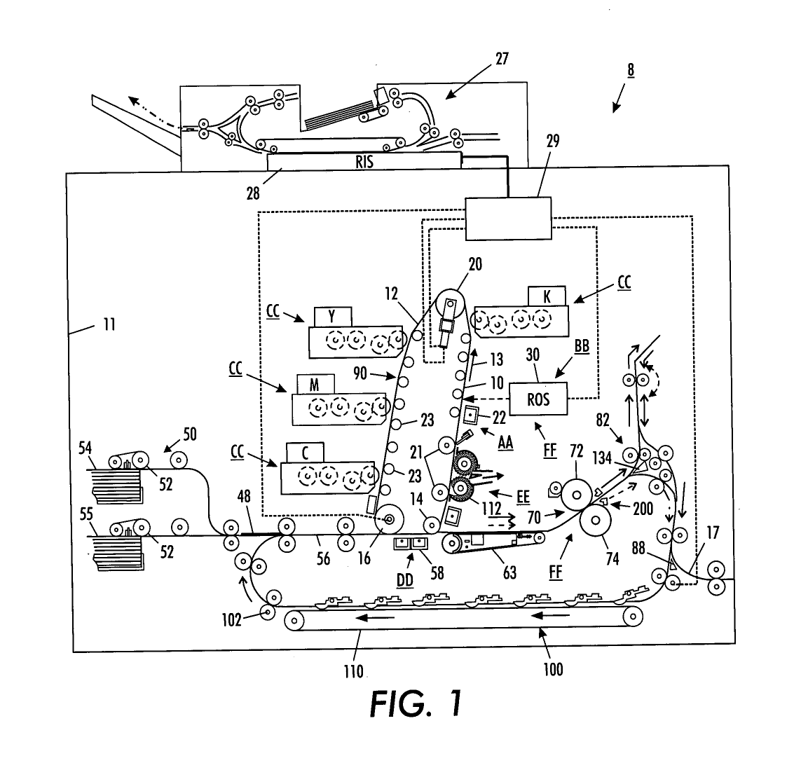

FIG. 1 is a schematic elevational view of an exemplary electrostatographic reproduction machine including a fusing apparatus including the sheet centering stripping assembly in accordance with the present disclosure;

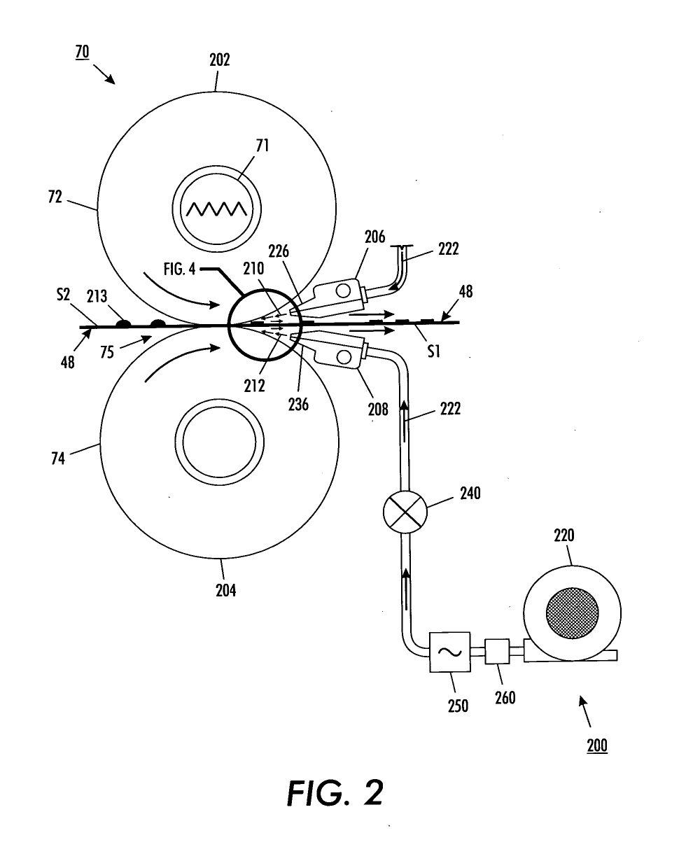

FIG. 2 is an enlarged end section schematic of the fusing apparatus of FIG. 1 showing the dual air knives of the sheet centering stripping assembly in accordance with the present disclosure;

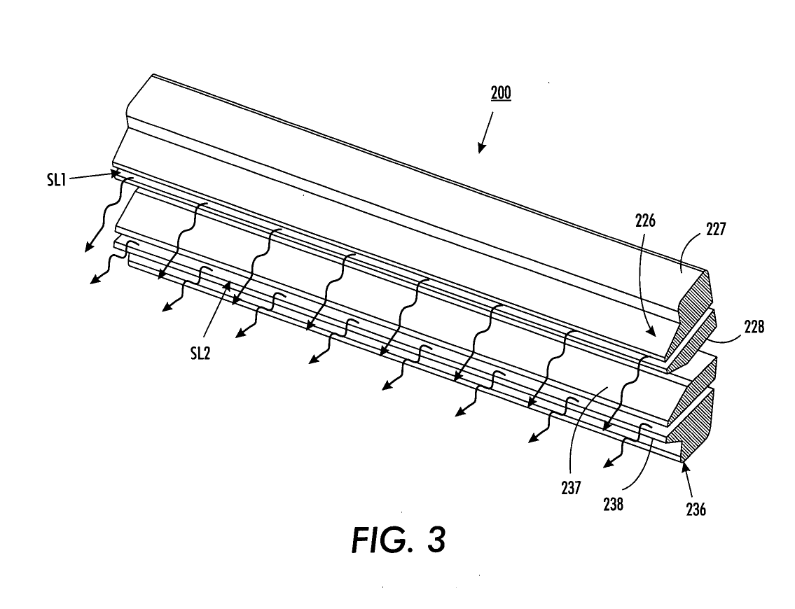

FIG. 3 is a front view illustration showing slits of the nozzles for the dual air knives of FIG. 2; and

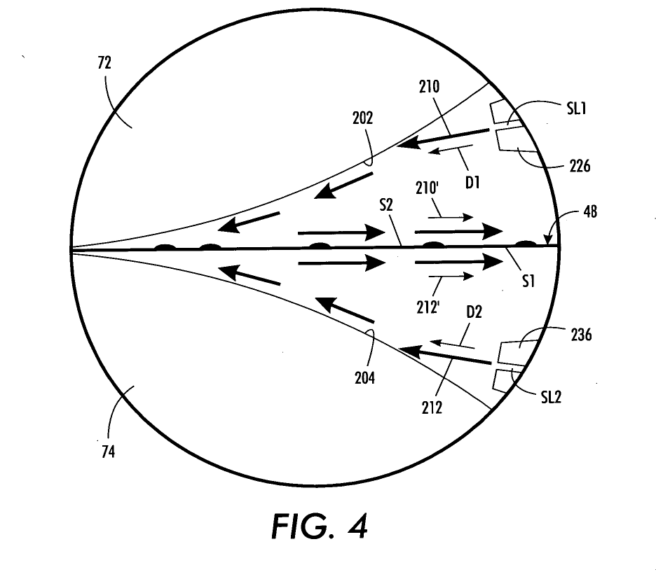

FIG. 4 is the enlarged portion of FIG. 2 within the circle.

Referring first to FIG. 1, it schematically illustrates an electrostatographic reproduction machine 8 that generally employs a photoconductive belt 10 mounted on a belt support module. Preferably, the photoconductive belt 10 is made from a photoconductive material coated on a conductive grounding layer. Belt 10 moves in the direction of arrow 13 to advance successive portions sequentially through various processing stations disposed about the path of movement thereof. Belt 10 is entrained as a closed loop 11 about stripping roll 14, drive roll 16, idler roll 21, and backer rolls 23.

Initially, a portion of the photoconductive belt surface passes through charging station AA. At charging station AA, a corona-generating device indicated generally by the reference numeral 22 charges the photoconductive belt 10 to a relatively high, substantially uniform potential.

As also shown the reproduction machine 8 includes a controller or electronic control subsystem (ESS) 29 that is preferably a self-contained, dedicated minicomputer having a central processor unit (CPU), electronic storage, and a display or user interface (UI). The ESS 29, with the help of sensors and connections, can read, capture, prepare and process image data and machine status information.

Still referring to FIG. 1, at an exposure station BB, the controller or electronic subsystem (ESS), 29, receives the image signals from RIS 28 representing the desired output image and processes these signals to convert them to a continuous tone or gray scale rendition of the image that is transmitted to a modulated output generator, for example the raster output scanner (ROS), indicated generally by reference numeral 30. The image signals transmitted to ESS 29 may originate from RIS 28 as described above or from a computer, thereby enabling the electrostatographic reproduction machine 8 to serve as a remotely located printer for one or more computers. Alternatively, the printer may serve as a dedicated printer for a high-speed computer. The signals from ESS 29, corresponding to the continuous tone image desired to be reproduced by the reproduction machine, are transmitted to ROS 30.

ROS 30 includes a laser with rotating polygon mirror blocks. At exposure station BB, the ROS 30 illuminates the charged portion on the surface of photoconductive belt 10. The ROS will expose the photoconductive belt 10 to record an electrostatic latent image thereon corresponding to the continuous tone image received from ESS 29. As an alternative, ROS 30 may employ a linear array of light emitting diodes (LEDs) arranged to illuminate the charged portion of photoconductive belt 10 on a raster-by-raster basis.

After the electrostatic latent image has been recorded on photoconductive surface 12, belt 10 advances the latent image through development stations CC containing the first color toner. Successive imaging stations and developer units containing other color toners, in the form of dry particles. At each developer unit the toner particles are appropriately attracted electrostatically to the latent image using commonly known techniques.

With continued reference to FIG. 1, after the electrostatic latent image is developed, the toner powder image present on belt 10 advances to transfer station DD. A print sheet 48 is advanced to the transfer station DD, by a sheet feeding apparatus 50. Sheet-feeding apparatus 50 may include a corrugated vacuum feeder (TCVF) assembly 52 for contacting the uppermost sheet of stack 54, 55. TCVF 52 acquires each top sheet 48 and advances it to vertical transport 56. Horizontal transport 56 directs the advancing sheet 48 through feed rolls into image transfer station DD to receive an image from photoreceptor belt 10 in a timed manner. Transfer station DD typically includes a corona-generating device 58 that sprays ions onto the backside of sheet 48. This assists in attracting the toner powder image from photoconductive surface 12 to sheet 48. After transfer, sheet 48 continues to move and is picked up by a pre-fuser transport assembly 63 and forwarded to fusing station FF.

Referencing FIG. 2, fusing station FF includes the fusing apparatus of the present disclosure that is indicated generally by the reference numeral 70 for fusing and permanently affixing the transferred toner powder image 213 to the copy sheet 48. Preferably, fusing apparatus 70 includes a heated fuser roller 72 having a surface 202, and a pressure roller 74 that form a fusing nip 75 through which the sheet 48 is passed with the powder image 213 on the copy sheet 48 contacting fuser roller 72. The pressure roller 74 is loaded against the fuser roller 72 forming the fusing nip 75 for providing the necessary pressure to fix the heated toner powder image 213 to the copy sheet. The fuser roll 72 for example is internally heated by a quartz lamp 71. The fuser roll surface 202 may be lubricated by a release agent, stored in a reservoir (not shown), for application to the surface of the fuser roll prior to the sheet contacting the surface 202. At the exit point of the fusing nip 75, sheet 48 separates from surfaces 202 and 204 by the sheet centering stripping assembly 200 of the present disclosure, (to be described in more detail below).

Referring to FIG. 1, sheet 48 then passes to a gate 88 that either allows the sheet to move directly via output 17 to a finisher or stacker, or deflects the sheet into the duplex path 100. Specifically, the sheet (when to be directed into the duplex path 100), is first passed through a gate 134 into a single sheet inverter 82. That is, if the second sheet is either a simplex sheet, or a completed duplexed sheet having both side one and side two images formed thereon, the sheet will be conveyed via gate 88 directly to output 17. However, if the sheet is being duplexed and is then only printed with a side one image, the gate 88 will be positioned to deflect that sheet into the inverter 82 and into the duplex loop path 100, where that sheet will be inverted and then fed to acceleration nip 102 and belt transports 110, for recirculation back through transfer station DD and fuser 70 for receiving and permanently fixing the side two image to the backside of that duplex sheet, before it exits via exit path 17.

After sheets separate from photoconductive surface 12 of belt 10, residual toner/developer and paper fiber particles remaining adhered to photoconductive surface 12 are removed from surface 12 by a cleaning apparatus 150 at cleaning station EE.

Referring now to FIGS. 1-4, the fusing apparatus 70 and the sheet centering stripping assembly 200 are illustrated in detail. As shown, the fusing apparatus or assembly 70 includes (a) the fuser roller 72 as a first rotatable fusing member having a first sheet contacting surface 202; (b) the pressure roller 74 as a second rotatable fusing member having a second sheet contacting surface 204 forming the fusing nip 75 against the first sheet contacting surface 202 of the first fusing member (72); and (c) the sheet centering stripping assembly 200 of the present disclosure for stripping a fused sheet 48 exiting the fusing nip 75 and having a still malleable toner image 213 thereon. The sheet centering stripping assembly 200 comprises (i) a first air knife device 206 for directing a first flat stream 210 of pressurized ionized air at a first force and a first pressure, such that the first flat stream 210 of pressurized ionized air is oriented to contact a first side of the fused sheet 48 exiting the fusing nip 75. The sheet centering stripping assembly 200 also comprises (ii) a second air knife device 208 for directing a second flat stream 212 of the pressurized ionized air at a second force and a second pressure, such that the second flat stream 212 of pressurized ionized air is oriented to contact the opposite side S2 of the fused sheet 48 exiting the fusing nip 75. The balance between the first force and first pressure with respect to the second force and second pressure, acts to prevent smudging of the malleable toner image 213 and to minimize curling of the fused sheet 48 exiting the fusing nip 75.

Referring to FIG. 2-4, the sheet centering stripping assembly 200 as illustrated includes a pneumatic means 220 connected to the first air knife device 206 and to the second air knife device 208 for supplying pressurized ionized air 222. The second force and the second pressure have a same magnitude as the first force and the first pressure. The second force however has a second direction D2 (FIG. 4) when moving towards the second surface 204 that relative to the sheet 48, is a mirror image of a first direction D1 of the first force moving towards the first surface 202. As shown in FIG. 4, this allows the deflected streams 210′ and 212′ to flow in a balancing manner on the opposite sides S1 and S2 of the sheet 48.

As illustrated in detail in FIG. 3, the first air knife device 206 includes a first nozzle member 226 having a first flat side 227 and a second flat side 228 defining a first nozzle slit SL1 for forming the first flat stream 210 of the pressurized ionized air 222. The second air knife device 208 includes a second nozzle member 236 having a third flat side 237 and a fourth flat side 238 defining a second nozzle slit SL2 for forming the second flat stream 212 of pressurized ionized air.

The pneumatic means 220 also includes air stream regulating means 240 for regulating aspects such as volume, pressure, direction of the pressurized air 222. The regulating means 240 is controlled for producing laminar flow of first flat stream 210. The regulating means 240 is controlled for producing laminar flow of the second flat stream 212. The sheet centering stripping assembly 200 may further include an ionizing device 250 for ionizing the pressurized air 222 in order to neutralize static build-up on the fused sheet 48. The sheet centering stripping assembly 200 may further include an air temperature controlling device 60 for cooling or heating the pressurized ionized air to a desired temperature.

To recapitulate, the sheet centering stripping assembly 200 includes the uniform air slit SL1, SL2 (over the entire span being equivalent to the media width. The uniform air supply provides for laminar flow and a uniform rate of media removal from the fuser members 72, 74. By using a uniform laminar air flow over the entire sheet width, there are no minute time release differences, and hence less likely to produce stripping related thermal defects since the laminar, uniform air stream 206, 208 remove the sheet as uniformly as possible. The incorporation of the second air knife; located on the underside of the media or sheet, equalizes air pressure on both sides of the sheet, balancing and keeping the media centered in the exit geometry of the post fusing nip region.

Additionally, in order to eliminate the static charge condition on the sheet 48 exiting the fusing nip; sheet centering stripping assembly 200 includes the ionizing device 250 for ionizing the pressurized air 222, to eliminate static electric charges on the sheet. When such ionized air comes in contact with static electric charges of an opposite polarity, those charges are neutralized. The sheet centering stripping assembly 200 thus provides a multiple solutions, (1) effectively addresses the static charge problem, (2) reduces the likelihood of image defects from the malleable toners exiting the fusing nip, and (3) a uniform exit path for media handling.

As can be seen, there has been provided a sheet centering stripping assembly for stripping a fused sheet exiting a fusing nip having a still malleable toner image thereon. The sheet centering stripping assembly includes (a) a first air knife device for directing a first flat stream of pressurized ionized air at a first force and a first pressure, the first flat stream of pressurized ionized air oriented to contact a first side of the fused sheet exiting the fusing nip; and (b) a second air knife device for directing a second flat stream of pressurized ionized air at a second force and a second pressure, the second flat stream of pressurized ionized air oriented to contact a second and opposite side of the fused sheet exiting the fusing nip, thereby preventing smudging of the malleable toner image, and minimizing curling of such fused sheet while improving sheet exit delivery.

It will be appreciated that various adaptations of the above-disclosed and other features and functions of this embodiment, or alternatives thereof, may be desirably combined into other different systems or applications. Therefore, unless specifically defined in a specific claim itself, steps or components of the invention should not be implied or imported from any above example as limitations to any particular order, number, position, size, shape, angle, color, or material. Additionally, it be appreciated that various presently unforeseen or unanticipated alternatives, modifications, variations or improvements therein may be subsequently made by those skilled in the art which are also intended to be encompassed by the following claims:

What is claimed is:

1. A sheet centering stripping assembly for stripping a fused sheet exiting a fusing nip having a still malleable toner image thereon, the sheet centering stripping assembly comprising:
(a) a first air knife device for directing a first flat stream of pressurized air at a first force to contact a first side of the fused sheet exiting the fusing nip; and
(b) a second air knife device for directing a second flat stream of pressurized air at a second force to contact a second and opposite side of the fused sheet exiting the fusing nip, thereby balancing air flow above and below the fused sheet to prevent smudging of the malleable toner image and minimize curling of such fused sheet.

2. The sheet centering stripping assembly of claim 1, including a pneumatic means connected to said first air knife device and to said second air knife device for supplying pressurized air.

3. The sheet centering stripping assembly of claim 1, wherein said second force has a same magnitude as said first force.

4. The sheet centering stripping assembly of claim 1, wherein said second force has a direction that relative to the fused sheet is a mirror image of said first force.

5. The sheet centering stripping assembly of claim 1, wherein said first air knife device includes a first nozzle member having a first flat side and a second flat side defining a first nozzle slit for forming said first flat stream of pressurized air.

6. The sheet centering stripping assembly of claim 1, wherein said second air knife device includes a second nozzle member having a third flat side and a fourth flat side defining a second nozzle slit for forming said second flat stream of pressurized air.

7. The sheet centering stripping assembly of claim 2, including air stream regulating means for regulating aspects of the pressurized air.

8. The sheet centering stripping assembly of claim 2, including an ionizing device for ionizing the pressurized air to neutralize static build-up on the fused sheet.

9. The sheet centering stripping assembly of claim 2, including an air temperature controlling device for controlling the pressurized air to a desired temperature.

10. The sheet centering stripping assembly of claim 7, wherein said regulating means is controlled for producing laminar flow of each of said first flat air stream and said second flat air stream.

11. A fusing assembly, in a toner image producing machine, comprising;
(a) a first rotatable fusing member having a first sheet contacting surface;
(b) a second rotatable fusing member having a second sheet contacting surface forming a fusing nip against said first sheet contacting surface of said first fusing member; and
(c) a sheet centering stripping assembly for stripping a fused sheet exiting a fusing nip having a still malleable toner image thereon, the sheet centering stripping assembly comprising:
(i) a first air knife device for directing a first flat stream of pressurized air at a first force to contact a first side of the fused sheet exiting the fusing nip; and
(ii) a second air knife device for directing a second flat stream of pressurized air at a second force to contact a second and opposite side of the fused sheet exiting the fusing nip, thereby balancing air flow above and below the fused sheet to prevent smudging of the malleable toner image and minimize curling of such fused sheet.

12. The fusing assembly of claim 11, including a pneumatic means connected to said first air knife device and to said second air knife device for supplying pressurized air.

13. The fusing assembly of claim 11, wherein said second force has a same magnitude as said first force.

14. The fusing assembly of claim 11, wherein said second force has a direction that relative to the fused sheet is a mirror image of said first force.

15. The fusing assembly of claim 11, wherein said first air knife device includes a first nozzle member having a first flat side and a second flat side defining a first nozzle slit for forming said first flat stream of pressurized air.

16. The fusing assembly of claim 11, wherein said second air knife device includes a second nozzle member having a third flat side and a fourth flat side defining a second nozzle slit for forming said second flat stream of pressurized air.

17. The sheet centering stripping assembly of claim 12, including air stream regulating means for regulating aspects of the pressurized air.

18. The sheet centering stripping assembly of claim 12, including an ionizing device for ionizing the pressurized air to neutralize static build-up on the fused sheet.

19. The sheet centering stripping assembly of claim 12, including an air temperature controlling device for controlling the pressurized air to a desired temperature.

20. The sheet centering stripping assembly of claim 17, wherein said regulating means is controlled for producing laminar flow of each of said first flat air stream and said second flat air stream.
